(19) United States
(12) Patent Application Publication
(10) Pub. No.: US 2015/0225603 A1
(43) Pub. Date: Aug. 13, 2015

(54) WEATHERABLE COATINGS

(71) Applicant: Dow Global Technologies LLC, Midland, MI (US)

(72) Inventors: Erin B. Vogel, Midland, MI (US); Ray E. Drumright, Midland, MI (US); Stephen W. King, League City, TX (US); Susan Machelski, Midland, MI (US); Jinghang Wu, Midland, MI (US); Tzu-Chi Kuo, Midland, MI (US)

(73) Assignee: Dow Global Technologies LLC, Midland, MI (US)

(21) Appl. No.: 14/422,612

(22) PCT Filed: Oct. 23, 2013
(86) PCT No.: PCT/US2013/066277

§ 371 Date: Feb. 19, 2015

Related U.S. Application Data
(60) Provisional application No. 61/717,657, filed on Oct. 24, 2012.

(51) Int. Cl. C09D 163/00; C08G 59/14

(52) U.S. Cl. CPC C09D 163/00; C08G 59/1477

(57) ABSTRACT

An adduct including a reaction product of (a) at least one cycloaliphatic amine compound, and (b) at least one cycloaliphatic epoxy resin compound; a curable epoxy resin coating composition including (i) the above adduct; and (ii) at least one thermosetting epoxy resin compound; and a cured weatherable coating prepared from the above curable composition.

### FIELD

The present invention is related to curable epoxy resin compositions useful in coating applications such as for preparing weatherable coatings useful in maintenance and protective coating applications.

### BACKGROUND

Epoxy resins are one of the most important classes of thermosetting polymers with greater than (>) about 50 percent (%) being used for maintenance and protective coating (M&PC) applications. Known epoxy resins useful in coating applications include for example resins based on bisphenol A diglycidyl ether (BADGE) which are popular in the industry (e.g., >75% of resin sales volume) because BADGE is readily available in the industry and because coatings based on BADGE exhibit a good balance of properties.

However, coatings derived from BADGE exhibit poor ultraviolet (UV) light resistance due to aromatic ether groups present in the chemical structure of BADGE. The poor ultraviolet (UV) light resistance property of BADGE based coatings creates difficulties with yellowing and chalking in exterior applications. The aromatic ether groups present in the chemical structure of BADGE absorb UV radiation leading to photooxidative degradation. For this reason, epoxy resin coatings are often overcoated with a durable top coat made from a polyurethane, an alkyd, or an acrylic composition in order to protect the under coating of epoxy from the effects of weathering.

Approximately 80% of the cost of a protective coating system comes from labor to prepare the surface to be coated and to apply the coatings. A weatherable epoxy coating could eliminate the requirement for a top coat in anticorrosion coating systems and provide significant systems savings in terms of costs of materials and labor efficiencies.

Some non-aromatic epoxy resin compounds are inherently UV resistant simply because the epoxy resin compounds lack aromatic ether linkages. For example, 1,4-cyclohexanedimethanol (CHDM) epoxy resin; hydrogenated bisphenol A epoxy resin; and Unoxol™ epoxy resin (an epoxy resin which is a mixture of 1,3 and 1,4 cis and trans cyclohexanedimethanol epoxy resin), are aliphatic epoxy resins that contain a cycloaliphatic ring. And, because such resins lack aromatic ether linkages, these aliphatic epoxy resin compounds are inherently UV resistant. On the other hand, aliphatic epoxides do not react effectively with conventional nucleophilic epoxy curing agents, such as amines, at ambient temperature (e.g. 25° C.). The lower reactivity at ambient temperature of the aliphatic epoxides arises (i) because the aliphatic epoxides are less susceptible to nucleophilic attack due to the lower electronegativity of the cycloaliphatic ring relative to standard aromatic epoxies, and (ii) because conventional amine curing agents lack compatibility with cycloaliphatic epoxy resins.

Furthermore, curing agents used with cycloaliphatic epoxy resins often require additional accelerators, such as 2,4,6-tris(dimethylaminomethyl)phenol (DMP-30) or salicylic acid to achieve ambient cure. Accelerators often negatively affect coating performance by introducing aromatic groups into the coating formulation. Thus, the curing agents have heretofore not been effectively used with cycloaliphatic epoxy resins in ambient temperature cure M&PC applications.

In addition, epoxy resins prepared by reacting aliphatic and cycloaliphatic diols with epichlorohydrin promoted by Lewis acids typically results in an epoxy resin containing a significant amount of chlorine due to oligomerization of epichlorohydrin onto the alcohol functionality. For example, U.S. Pat. No. 4,310,695 and U.S. Pat. No. 4,316,003 describe making epoxy resins from aliphatic alcohols and such epoxy resins contain chlorine in concentrations of from 1% to 7% chlorine. This bound chlorine provides unwanted sites for reaction with amines during adduct preparation and results in the release of chlorides into a composition. These adducts derived from high chlorine containing epoxies have an undesirable high viscosity and low reactivity. When such adducts derived from high chlorine containing epoxies are subsequently cured with epoxy to yield coatings, these high chloride containing adducts provide low coating performance properties such as gloss, water resistance, and corrosion resistance.

### SUMMARY

The present invention addresses the above-mentioned problems facing the coating industry by synthesizing a curable coating formulation or composition that provides a coating product having advantageous weatherable properties.

One embodiment of the present invention is directed to an adduct including a reaction product of (a) at least one amine compound, and (b) at least one epoxy resin compound; wherein the at least one epoxy resin compound comprises 1,4-cyclohexanedimethanol epoxy resin; hydrogenated bisphenol A epoxy resin; Unoxol epoxy resin; or mixtures thereof. For example, in one preferred embodiment, the amine compound used to form the adduct can be an ethyleneamine compound such as for example bis(2-(piperazin-1-yl)ethyl)amine (BPEA); and the at least one cycloaliphatic epoxy resin compound can be for example CHDM epoxy resin.

Another embodiment of the present invention is directed to a curable epoxy resin composition comprising (i) the above adduct, and (ii) at least one thermosetting epoxy resin compound.

Still another embodiment of the present invention is directed to a coating prepared from the above curable composition.

Yet other embodiments of the present invention are directed to processes for manufacturing the above adduct, curable composition, and coating.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a graphical illustration showing dry times of coatings from BPEA and isophoronediamine (IPDA) adducted with CHDM epoxy resin curing CHDM epoxy resin at ambient temperature (Examples of the present invention). Adducts prepared with diethylenetriamine (DETA) and triethylenetetraamine (TETA) were not compatible with the CHDM epoxy resin and yielded no readable dry time over the 24 hour test duration. “Compatibility” or “compatible” herein is defined in terms of gloss of a cured coating for example wherein the cured coating from a compatible curing composition has an initial gloss of greater than about 80 at about 60° and a dry through time of less than 36 hours.

FIG. 2 is a graphical illustration showing dry times of coatings from IPDA adducted with CHDM epoxy resin curing CHDM epoxy resin at ambient temperature and dry times of blends of IPDA and BPEA adducted with CHDM curing CHDM epoxy resin at ambient temperature.

FIG. 3 is a graphical illustration showing dry times of pigmented coatings from adducted cycloaliphatic amines from CHDM epoxy resin curing a formulated CHDM epoxy composition at ambient temperature.

FIG. 4 is a graphical illustration showing % cure by DSC of coatings from adducted cycloaliphatic amines with CHDM epoxy resin (BPEA, AEP, and IPDA adducts), curing CHDM epoxy resin.

FIG. 5 is a graphical illustration showing dry times of coatings from adducted cycloaliphatic amines with hydrogenated BADGE resin (BAC, BPEA, IPDA) curing hydrogenated BADGE resin.

FIG. 6 is a graphical illustration showing the gloss retention of a coating derived from a BPEA/IPDA adduct cured with a formulated CHDM epoxy resin.

FIG. 7 is a graphical illustration showing the gloss of coatings as a function of accelerated weathering and the influence of UV stabilizers on performance.

### DETAILED DESCRIPTION

A curable composition can be formulated when one of the components of a curable composition includes a thermoset resin such as an epoxy resin compound and the other component of the curable composition is a curing agent (also referred to as a hardener or cross-linking agent) which is used to cure a thermosetting resin compound to form a thermoset resin matrix. In the present invention the component used as the curing agent in a curable composition of the present invention is an adduct composition. Accordingly, one broad embodiment of the present invention is directed to providing an adduct composition for use as a curing agent for an epoxy resin composition; and another broad embodiment of the present invention is directed to providing a curable epoxy resin composition containing such adduct.

For example, one embodiment of the present invention includes an adduct comprising a reaction product of (a) at least one amine compound such as for example BPEA or high molecular weight BPEA oligomers; and (b) at least one epoxy resin compound such as 1,4-cyclohexanedimethanol epoxy resin (CHDM epoxy resin); hydrogenated bisphenol A epoxy resin; Unoxol™ epoxy resin; or mixtures thereof. In one embodiment, for example, the cycloaliphatic amine compound may comprise BPEA; and the epoxy resin compound may comprise CHDM epoxy resin.

The amine compound useful in preparing the adduct of the present invention may include various cycloaliphatic amine compounds. For example, the cycloaliphatic amine compounds useful in the present invention may include the cycloaliphatic amine compounds described in U.S. Provisional Patent Application Ser. No. 61/581,323 entitled “Formation of Higher Molecular Weight Cyclic Polyamine Compounds From Cyclic Polyamine Compounds” filed Dec. 29, 2011 by Stephen King., incorporated herein by reference. Examples of the cycloaliphatic amine compounds useful in the present invention include BPEA, (3-(piperazin-1-yl)propyl)amine, bis(4-(piperazin-1-yl)butyl)amine, bis(5-(piperazin-1-yl)pentyl)amine, bis(6-(piperazin-1-yl)hexyl)amine, bis(1-(piperazin-1-yl)propan-2-yl)amine, bis(2-(piperazin-1-yl)propyl)amine, and mixtures thereof.

Other high molecular weight cycloaliphatic amine compounds useful in the present invention include for example 2-(4-(2-(piperazin-1-yl)ethyl)piperazin-1-yl)ethanamine, 3-(4-(3-(piperazin-1-yl)propyl)piperazin-1-yl)propan-1-amine, 4-(4-(4-(piperazin-1-yl)butyl)piperazin-1-yl)butan-1-amine, 5-(4-(5-(piperazin-1-yl)pentyl)piperazin-1-yl)pentan-1-amine, 6-(4-(6-(piperazin-1-yl)hexyl)piperazin-1-yl)hexan-1-amine, 1-(4-(1-(piperazin-1-yl)propan-2-yl)piperazin-1-yl)propan-2-amine, 2-(4-(2-(piperazin-1-yl)propyl)piperazin-1-yl)propan-1-amine, and mixtures thereof.

One preferred embodiment of the cycloaliphatic amine compound useful in preparing the adduct of the present invention includes for example BPEA; high molecular weight BPEA oligomers; and mixtures thereof. An oligomer refers to a compound incorporating from two to ten repeating units.

Other cycloaliphatic diamines that may be used in preparing the adduct of the present invention may include for example aminoethylpiperazine (AEP), bis(4-aminocyclohexyl)methane (PACM), diaminocyclohexane (DACH), bis(aminomethyl)cyclohexane (BAC), or isophorone diamine (IPDA), or mixtures thereof.

The concentration of the amine compound in the reaction mixture to form the adduct can be measured in terms of molecular equivalents of active hydrogen (N-H group) to the epoxy group of the epoxy resin. Generally, the molar equivalents of the reactive N-H group in the amine compound to the epoxy group of the epoxy resin used in preparing the adduct of the present invention may range up to about 20 molar equivalents in one embodiment, up to about 18 mole equivalents in another embodiment, up to about 15 mole equivalents in still another embodiment, and up to about 12 mole equivalents in yet another embodiment, based on the moles of epoxy components in the adduct composition. Generally, the molar equivalents of active hydrogen (N-H) in the cycloaliphatic amine compound used in preparing the adduct of the present invention may range generally from about 2 to about 20 in one embodiment, from about 3 to about 18 in another embodiment, from about 5 to about 15 in still another embodiment, and from about 8 to about 12 in yet another embodiment, based on the moles of epoxy functionality used in preparing the adduct.

The adduct composition of the present invention may include one epoxy resin compound or a mixture of two or more epoxy resin compounds. For example, in one embodiment the epoxy resin compound may include at least one cycloaliphatic epoxy resin compound such as CHDM epoxy resin; Unoxol™ epoxy resin; hydrogenated bisphenol A epoxy resin; and mixtures thereof.

In one preferred embodiment, the ratio of amine N-H to epoxy resin used to prepare the adduct can be in the range of from about 2:1 to about 20:1 (NH:epoxide ratio); from about 5:1 to about 15:1 in another embodiment; and from about 8:1 to about 12:1 in still another embodiment.

The adduct composition of the present invention may include optional compounds or additives useful for their intended purpose. For example the adduct may optionally include accelerators, catalysts, defoamers, pigments, solvents, and plasticizers.

The amount of optional compounds used will depend on the specific starting materials used for preparing the adduct; and the application in which the adduct will be used. Generally, the amount of optional compounds or additives used in the adduct composition of the present invention, may be for example, from 0 wt % to about 70 wt % in one embodiment, from about 0.01 wt % to about 60 wt % in another embodiment; and from about 5 wt % to about 50 wt % in still another embodiment, based on the total weight of the adduct composition. These amounts can be determined by the skilled artisan.

The process for preparing the adduct composition of the present invention includes admixing (a) at least one amine compound for example BPEA; and (b) at least one epoxy resin compound for example CHDM epoxy resin; and any other optional ingredients as needed. The preparation of the adduct formulation of the present invention can be achieved by blending, in known mixing equipment, the BPEA, the epoxy compound, and optionally any other desirable additives. The compounds may be admixed in any order to provide the adduct composition.

All the compounds of the adduct formulation are typically mixed and reacted at a temperature enabling the preparation of an effective adduct composition for a particular application such as for a coating composition. For example, the temperature during the mixing and reacting of all components may be generally from about 10° C. to about 200° C. in one embodiment, and from about 20° C. to about 150° C. in another embodiment.

The preparation of the adduct formulation of the present invention, and/or any of the steps thereof, may be a batch or a continuous process. The mixing equipment used in the process may be any vessel and ancillary equipment well known to those skilled in the art.

In order to formulate the curable composition of the present invention, the curable epoxy resin formulation or composition includes (i) the above-described adduct useful as a curing agent, and (ii) at least one thermosetting epoxy resin compound. Other optional additives known to the skilled artisan can be included in the curable composition such as for example a curing catalyst and other additives for various end use applications.

The adduct used as the curing agent in the curable composition of the present invention as component (i) comprises the adduct as described above.

The amount of the adduct in the reaction mixture used to prepare the curable composition can be measured in terms of molecular equivalents. The molar equivalence of the amine hydrogens (N-H) of adduct composition used in the curable composition of the present invention may range generally from about 0.5 to about 1.5 mole equivalents in one embodiment, from about 0.6 to about 1.3 mole equivalents in another embodiment, from about 0.7 to about 1.1 mole equivalents in still another embodiment based on the moles of epoxy of the curable composition. If the concentration of the adduct is outside the above listed ranges, the adduct will either be present in significant excess or depletion, which creates coatings that will not be fully cured and will have poor final coating properties.

The thermosetting epoxy compound useful as component (ii) in preparing a curable composition of the present invention may comprise, for example, any one or more epoxy resins, including for example aromatic, aliphatic and cycloaliphatic epoxy resins; and mixtures thereof.

In one embodiment, the thermosetting epoxy compound useful as component (ii) in preparing a curable composition of the present invention may comprise, for example, any one or more of the epoxy compounds described above with reference to an adduct composition, i.e., the thermosetting epoxy compounds useful in the present invention may include for example at least one aliphatic or cycloaliphatic epoxy compound which can be the same or different from the cycloaliphatic epoxy resin compound used to form the adduct. For example, the thermosetting epoxy compound useful in the present invention may include any other conventional epoxy compound.

One embodiment of the thermosetting epoxy compound used in the curable composition of the present invention, may be for example a single epoxy compound; or a combination of two or more epoxy compounds known in the art such as any of the epoxy compounds described in Lee, H. and Neville, K., Handbook of Epoxy Resins, McGraw-Hill Book Company, New York, 1967, Chapter 2, pages 2-1 to 2-27, incorporated herein by reference. For example, in a preferred embodiment, the thermosetting epoxy compound may include for example epoxy resins based on reaction products of polyfunctional alcohols or cycloaliphatic carboxylic acids with epichlorohydrin, or mixtures thereof.

A few non-limiting embodiments of the epoxy resins useful in the present invention include, for example, the epoxy resins of cycloalkanedimethanols such as cyclohexanedimethanol; cycloalkane diols such as tetramethylcyclobutanediol; alkane diols such as butane or hexane diol; alkane triols such as trimethylolpropane; hydrogenated polyphenols such as hydrogenated bisphenol A or hydrogenated bisphenol F; cycloalkane diacids such as cyclohexanedicarboxylic acid; an alkane diacids such as succinic acid and dimer fatty acid; and mixtures thereof. Other suitable thermosetting epoxy resins known in the art include for example reaction products of epichlorohydrin with hydrocarbon novolacs. The thermosetting epoxy compound may also be selected from commercially available epoxy resin products such as for example, D.E.R. 330, 331, 332, 353, 671, 438, 732, and 736 epoxy resins available from The Dow Chemical Company; and mixtures thereof.

Preferred specific embodiments of the thermosetting epoxy resin useful in the present invention can include for example CHDM epoxy resin, Unoxol™ epoxy resin, hydrogenated bisphenol A epoxy resins, and mixtures thereof. Other preferred embodiments of the thermosetting epoxy resin useful in the present invention may include for example epoxy resins of bisphenol A; epoxy resins of bisphenol F; epoxy resin of propylene glycol; and mixtures thereof.

The molar equivalence of thermosetting epoxy compound used in the curable composition of the present invention as the epoxy resin compound may range generally from about 0.7 molar equivalents to about 2 molar equivalents in one embodiment, from about 0.8 molar equivalents to about 1.7 molar equivalents in another embodiment, from about 0.9 molar equivalents to about 1.4 molar equivalents in still another embodiment based on the moles of active amine hydrogen (N-H) in the curable composition. If the concentration of the thermosetting epoxy compound is outside the above listed ranges, the thermosetting epoxy compound will either be present in significant excess or depletion, which creates coatings that will not be fully cured and will have poor final coating properties.

In addition to the adduct used as a curing agent in the curable composition of the present invention, an additional optional curing agent can be used for the thermosetting epoxy compound. For the optional curing agent, any conventional curing agent known in the art useful for including in a curable composition can be used in combination with the adduct of the present invention if desired.

The optional curing agent useful in the curable composition, may be selected, for example, but are not limited to, anhydrides, carboxylic acids, thiol compounds, amine compounds, or mixtures thereof.

Generally, the optional conventional curing agent known in the art can be blended with the adduct, component (i) or the optional conventional curing agent can be blended with the thermosetting epoxy resin compound, component (ii), to prepare the curable composition.

Preferred embodiments of other curing agents blended with the adduct curing agents useful in the present invention may include for example polyamides; polyamines; polymercaptans; Mannich bases; and mixtures thereof.

The molar equivalence of the active hydrogens of the adduct composition used in the curable composition of the present invention may range generally from about 0.5 mole equivalents to about 1.5 mole equivalents in one embodiment, from about 0.6 mole equivalents to about 1.3 mole equivalents in another embodiment, from about 0.7 mole equivalents to about 1.1 mole equivalents in still another embodiment based on the moles of epoxy of the curable composition. If the concentration of the adduct is outside the above listed ranges, the adduct will either be present in significant excess or depletion, which creates coatings that will not be fully cured and will have poor final coating properties.

Other optional compounds that may be added to the curable composition of the present invention may include compounds that are normally used in resin formulations known to those skilled in the art for preparing curable compositions and thermosets. For example, the optional components may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

Other optional compounds that may be added to the curable composition of the present invention may include, for example, a curing catalyst or accelerator to modulate the curing time of the composition; a solvent to lower the viscosity of the formulation, other epoxy resins such as for example, aliphatic glycidyl ethers; cycloaliphatic epoxy resins; pigments, toughening agents, flow modifiers, adhesion promoters, diluents, stabilizers, accelerators, catalysts, catalyst de-activators, flame retardants, plasticizers; fillers including for example finely divided minerals such as silica, alumina, zirconia, talc, sulfates, TiO₂, carbon black, graphite, silicates and the like; other curing agents; other epoxy resins; reinforcing agents; rheology modifiers; surfactants; UV stabilizers; antioxidants; wetting agents; colorants including pigments, dyes, and tints; and mixtures thereof.

Generally, the amount of optional compounds or additives used in the adduct composition of the present invention, may be for example, from 0 wt % to about 70 wt % in one embodiment, from about 0.01 wt % to about 60 wt % in another embodiment; and from about 5 wt % to about 50 wt % in still another embodiment, based on the total weight of the adduct composition. The amount of optional compounds used will depend on the specific compounds used in the composition.

As one illustration, for example, when an accelerator is used, the amount can be from about 0.1 wt % to about 10 wt % for an accelerator such as tris-2,4,6-dimethylaminomethyl phenol. In another illustration, for example, when an accelerator like benzyl alcohol is used, the amount of such an accelerator can be from about 5 wt % to about 70 wt %. These amounts can be determined by the skilled artisan.

In another embodiment of the present invention, a stabilizer compound can be added to the curable epoxy resin composition. Generally, the stabilizer may include for example a UV stabilizer or a thermal stabilizer or a mixture of these two stabilizers. These stabilizers may prevent or reduce the degradation of the coatings by UV radiation or thermal exposure. Any conventional UV stabilizer or thermal stabilizer known to a person of ordinary skill in the art may be added to the formulation disclosed herein. Non-limiting examples of suitable UV stabilizers include hydroxyphenyl benzophenones, hydroxyphenyl benzotriazoles, hydroxyphenyl-s-triazines, acrylesters, oxanilides, acrylic esters, formadines, carbon black, hindered amine light stabilizers such as derivatives of 2,2,6,6-tetramethyl piperidine, nickel quenchers, phenolic antioxidants, metallic slats, zinc compounds, hydroquinone, p-methoxyphenol, pyrogallol, chloranil, cuprous chloride and combinations thereof.

In a preferred embodiment of the present invention wherein a UV stabilizer is used, the curable epoxy resin composition of the present invention includes UV stabilizers such as for example UV absorber Tinuvin® 123 and radical scavenger Tinuvin® 400.

Generally, the amount of the stabilizer used in the curable composition of the present invention will depend on the enduse of the curable composition. For example, as one illustrative embodiment, when the curable composition is used to prepare a composite, the concentration of stabilizers can be generally from about 1 wt % to about 10 wt % of the curable composition in one embodiment, from about 1 wt % to about 6 wt % of the curable composition in another embodiment; from about 1 wt % to about 4 wt % of the curable composition in still another embodiment; and from about 1 wt % to about 2 wt % of the curable composition in yet another embodiment.

The process for preparing the curable composition of the present invention includes admixing (i) the above adduct, (ii) at least one thermosetting epoxy resin compound, and (iii) optionally, other optional ingredients as needed. For example, the preparation of the curable resin formulation of the present invention is achieved by blending, in known mixing equipment, the epoxy compound, and the adduct, and optionally any other desirable additives. Any of the above-mentioned optional additives, for example a curing catalyst, may be added to the composition during the mixing or prior to the mixing to form the composition.

All the compounds of the curable formulation are typically mixed and dispersed at a temperature enabling the preparation of an effective curable epoxy resin composition having the desired balance of properties for a particular application. For example, the temperature during the mixing of all components may be generally from about 5° C. to about 100° C. in one embodiment, and from about 10° C. to about 50° C. in another embodiment. Lower mixing temperatures help to minimize reaction of the epoxide and adduct curing agent in the composition to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

Epoxy resins prepared from reaction of aliphatic and cycloaliphatic diols using non-Lewis acid processes contain low bound chlorine; and as aforementioned above, problems encountered by the prior art epoxy systems can be averted. In addition, an added benefit of epoxy resins prepared from aliphatic and cycloaliphatic diols using non-Lewis acid processes is that these epoxy resins possess low levels of monoglycidyl ether and moderate to high levels of oligomeric product with an average epoxide functionality greater than 2. Due to the presence of low monoglycidyl ether and moderate to high levels of higher functional oligomers, coatings derived from these resins display superior crosslink density, and therefore, superior chemical resistance properties.

Therefore, when the above-described epoxy resins are used to prepare the adduct compositions of the present invention, the resulting adduct compositions advantageously do not have a problem with chlorine content. In addition, curable compositions prepared from the above adduct composition and epoxy resins can also advantageously have low chlorine, low monoglycidyl ether, and an oligomeric component with an average functionality greater than 2.

The amount of oligomer content in the epoxy resin generally can be from about 5 wt % to about 25 wt % in one embodiment, from about 5 wt % to about 20 wt % in another embodiment, and from about 10 wt % to about 20 wt % in still another embodiment, based on the weight of the epoxy resin. The amount of chlorine content in the epoxy resin generally can be from 0 wt % to about 4 wt % in one embodiment, from about 0.001 wt % to about 2 wt % in another embodiment, and from about 0.001 wt % to about 1 wt % in still another embodiment, based on the weight of the epoxy resin. The amount of monoglycidyl ether in the epoxy resin generally can be from 0 wt % to about 10 wt % in one embodiment, from about 0.001 wt % to about 8 wt % in another embodiment, and from about 0.001 wt % to about 5 wt % in still another embodiment, and from about 0.001 wt % to about 2 wt % in yet another embodiment, based on the weight of the epoxy resin. Other minor components may be present as a component of the epoxy resin used to prepare the compositions of the present invention. Generally, said minor components may be present in an amount of from 0 wt % to about 5 wt % in one embodiment, from about 0.001 wt % to about 2 wt % in another embodiment, and from about 0.001 wt % to about 0.5 wt % in still another embodiment, based on the weight of the epoxy resin.

The epoxy resins prepared from hydroxyl compounds via non-Lewis acid processes display an epoxide equivalent weight (EEW) of no more than about 20% higher than the theoretical EEW in one embodiment, less than about 15% higher than the theoretical EEW in another embodiment, and less than about 10% higher than the theoretical EEW in one embodiment, of the chemically pure diglycidyl ether derived from the same hydroxyl compound.

Cycloaliphatic epoxy resins prepared from hydrogenation of aromatic epoxy resins contain low bound chlorine therefore averting the aforementioned problems common to epoxy resins obtained by reacting aliphatic alcohols with epichlorohydrin with Lewis-acid processes. The cycloaliphatic epoxy resins prepared from hydrogenation of aromatic epoxy compounds display an EEW of no more than about 20% higher than the theoretical EEW in one embodiment, less than about 15% higher than the theoretical EEW in another embodiment, and less than about 10% higher than the theoretical EEW in one embodiment, of the chemically pure hydrogenated diglycidyl ether.

The process of the present invention includes curing the curable resin composition to form a thermoset or cured composition. In one embodiment, the curable resin composition can be advantageously cured at ambient temperature. For example, the “ambient temperature” herein means from about −10° C. to about 50° C. in one embodiment and from about 10° C. to about 40° C. in another embodiment.

Generally, the BYK dry through time of the composition at ambient temperature may be less than about 48 hours in one embodiment, from 2 hours to about 48 hours in another embodiment, between about 4 hours to about 36 hours in still another embodiment, and between about 6 hours to about 24 hours in yet another embodiment.

In another embodiment, the curable resin composition can be cured by forced cure at higher temperatures. For example, the process of curing of the curable composition may be carried out at a predetermined temperature and for a predetermined period of time sufficient to cure the composition. For example, the temperature of curing the formulation may be generally from about 10° C. to about 200° C. in one embodiment; from about 50° C. to about 175° C. in another embodiment; and from about 60° C. to about 150° C. in still another embodiment.

Generally, the curing time for a forced cure temperature may be chosen between about 1 minute to about 4 hours in one embodiment, between about 5 minutes to about 2 hours in another embodiment, and between about 10 minutes to about 1.5 hours in still another embodiment.

Both ambient temperature cure and forced cure at higher temperatures provide a final cured product with desired properties.

The cured product (i.e. the cross-linked product made from the curable composition) useful as a weatherable coating of the present invention shows several improved properties over conventional epoxy cured resins. For example, the cured weatherable coating of the present invention may advantageously have low chlorine content and a high glass transition temperature (Tg).

For example, the cured product of the present invention generally exhibits a glass transition temperature of greater than 20° C. in one embodiment, and from about 20° C. to about 200° C. in another embodiment. The Tg of the cured product can be measured by a differential scanning calorimetry (DSC) or a dynamic mechanical analysis (DMA) method.

For example, the cured product of the present invention generally exhibits at total chlorine level of less than about 2 wt % in one embodiment, and less than about 1 wt % in another embodiment, and less than about 0.5 wt % in still another embodiment. The total chlorine level of the cured product can be measured by neutron activation or spectroscopic methods.

The cured product of the present invention generally exhibits good weatherability. In one embodiment the gloss retention upon accelerated weathering according to ASTM D4587-11 after 500 hours is from about 30% to 100%, from about 50% to 100% in another embodiment, and from about 70% to 100% in yet another embodiment.

The curable composition of the present invention may be used to manufacture a cured thermoset weatherable coating product. In particular, for example, the curable composition may be used to prepare a weatherable coating for maintenance and protective coating (M&PC) applications. Other enduse applications may include UV cure formulations for inks and coatings, and laminate applications.

### EXAMPLES

The following examples and comparative examples further illustrate the present invention in detail but are not to be construed to limit the scope thereof.

Various materials used in the following examples included different streams of CHDM or Unoxol™ epoxy resins with epoxide equivalent weight ranges from 128 to 150; and BPEA, said materials available from The Dow Chemical Company.

Various terms and designations used in the following examples are explained herein below:

“BPEA” stands for bis(2-(piperazin-1-yl)ethyl)amine.

“CHDM” stands for cyclohexanedimethanol.

“CHDM DGE” stands for 1,4-cyclohexanedimethanol diglycidyl ether.

“H-LER” stands for hydrogenated bisphenol A epoxy resin.

“AEP” stands for aminoethyl piperazine.

“IPDA” stands for isophorone diamine.

“1,3-BAC” stands for bis-aminomethylcyclohexane.

“AHEW” stands for amine hydrogen equivalent weight.

“DETA” stands for diethylenetriamine.

“TETA” stands for triethylenetetraamine.

“H-BADGE” stands for hydrogenated bisphenol A epoxy resin.

Bentone SD-2 is an organically modified bentonite clayrheology modifier commercially available from Elementis.

Ti-Pure R-706 is titanium dioxide commercially available from DuPont.

Imsil 1240 is silica filler commercially available from Unimin Corporation.

Cimbar UF is barium sulfate pigment (barite) commercially available from Cimbar Performance Minerals.

“EEW” stands for epoxide equivalent weight.

D.E.R. 331 is an aromatic epoxy resin epoxy resin having an EEW of 190 and commercially available from The Dow Chemical Company.

Erisys GE 22 is an epoxy resin from CVC Specialty Thermosets with an EEW of 160 and a total chlorine level of 5.5 wt %.

### Examples 1-11, and Comparative Examples A-D

### Adduct Synthesis

Adducts were prepared according to the description below for Example 2. BPEA, 100 g, (amine hydrogen is 8 molar times of epoxide) and 22.1 g of CHDM epoxy resin (EEW of 142) were charged into a reactor and mixed. The mixer was set at about 250 revolutions per minute (rpm) to 300 rpm the two ingredients were mixed well. A nitrogen blanket was introduced into the reactor and the reactor was equipped with a cold water condenser.

The reactor was lowered into a pre-heated 50° C. oil bath while monitoring the internal temperature for an exothermic reaction. The temperature of the oil bath was increased 10° C. every 20 minutes until the oil bath temperature reached 100° C. and then was held for 20 minutes. The reaction was then cooled and the resulting product collected.

As shown in Table 1, a number of adducts were prepared using the above procedure except for varying the moles amine NH:mole epoxy and the type of epoxy resin and amine.

TABLE 1
Adducts Prepared with Amines and Epoxy Resins

| | | | Theo- |
|---|---|---|---|
| | | Moles Amine | retical |
| Example | Adduct Hardener | NH:mole epoxy | AHEW |
| Example 1 | BPEA:CHDM Epoxy Resin | 15 | 96 |
| Example 2 | BPEA:CHDM Epoxy Resin | 8 | 112 |
| Example 3 | BPEA:CHDM Epoxy Resin | 4 | 155 |
| Comparative | BPEA:DER 331 | 15 | 100 |
| Example A | | | |
| Comparative | BPEA:DER 331 | 8 | 119 |
| Example B | | | |
| Example 4 | AEP:CHDM Epoxy Resin | 8 | 69 |
| Comparative | AEP:DER 331 | 15 | 59 |
| Example C | | | |
| Example 5 | IPDA:CHDM Epoxy Resin | 12 | 59 |
| Example 6 | IPDA:CHDM Epoxy Resin | 8 | 69 |
| Comparative | IPDA:DER 331 | 12 | 64 |
| Example D | | | |
| Example 7 | 1,3 BAC:CHDM Epoxy Resin | 8 | 61 |
| Comparative | DETA:CHDM Epoxy Resin | 8 | 44 |
| Example E | | | |
| Comparative | TETA:CHDM Epoxy Resin | 8 | 40 |
| Example F | | | |
| Example 8 | IPDA:H-BADGE | 10 | 70 |
| Example 9 | BPEA:H-BADGE | 10 | 112 |
| Example 10 | 1,3 BAC:H-BADGE | 10 | 62 |
| Comparative | IPDA:Erisys GE 22 | 12 | 59 |
| Example G | | | |
| Example 11 | BPEA/IPDA (1/1):CHDM | 10 | 78 |
| | Epoxy Resin | | |

### Examples 12-28 and Comparative Examples H-J

### Curable Composition Preparation and Dry Time Measurements

Coating formulations as described in Table 2 were prepared by mixing the curing agent with the indicated epoxy at a 1:1 NH:epoxy stoichiometric ratio unless indicated otherwise. The coatings were then drawn down onto glass substrates with a wet film thickness of 76 μm and drying evaluated on a BYK drying time recorder. The set-to-touch, tack-free, and dry-through times were measured by dragging a needle through the coating using a BYK drying time recorder according to ASTM D5895-03 at ambient temperature (25° C.).

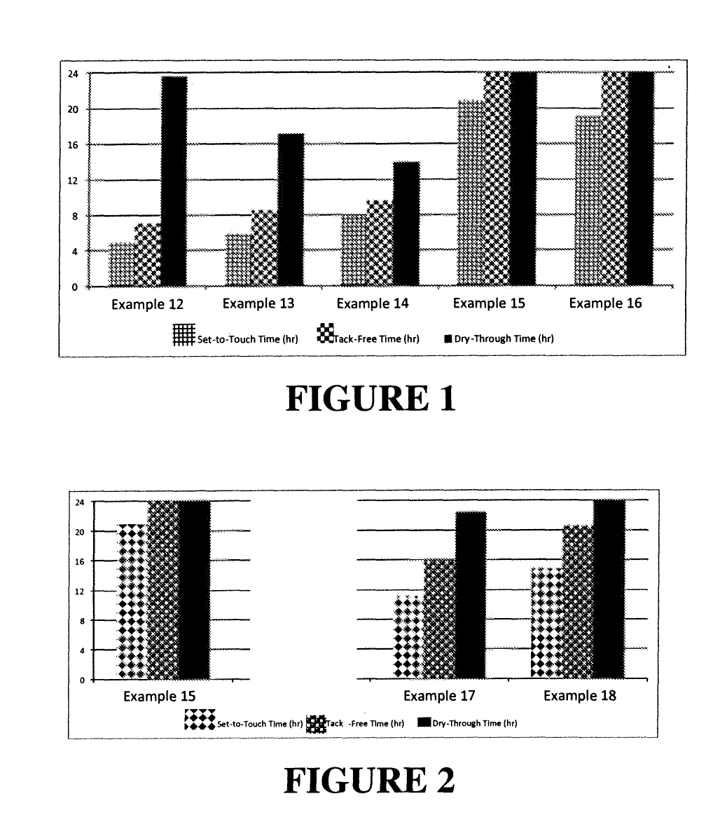

FIG. 1 shows the dry times of clear aliphatic epoxy coatings from adducted cycloaliphatic amines with CHDM epoxy resin, EEW 142, and the impact of accelerator and stoichiometry on the set to touch, tack free, and dry through times. Adducts prepared from DETA and TETA (Comparative Examples E and F) yielded no readable dry time over the 24 hour test duration.

FIG. 2 shows the acceleration of dry times of clear aliphatic epoxy coatings prepared from blends of adducted cycloaliphatic amines with CHDM epoxy resin, EEW 142.

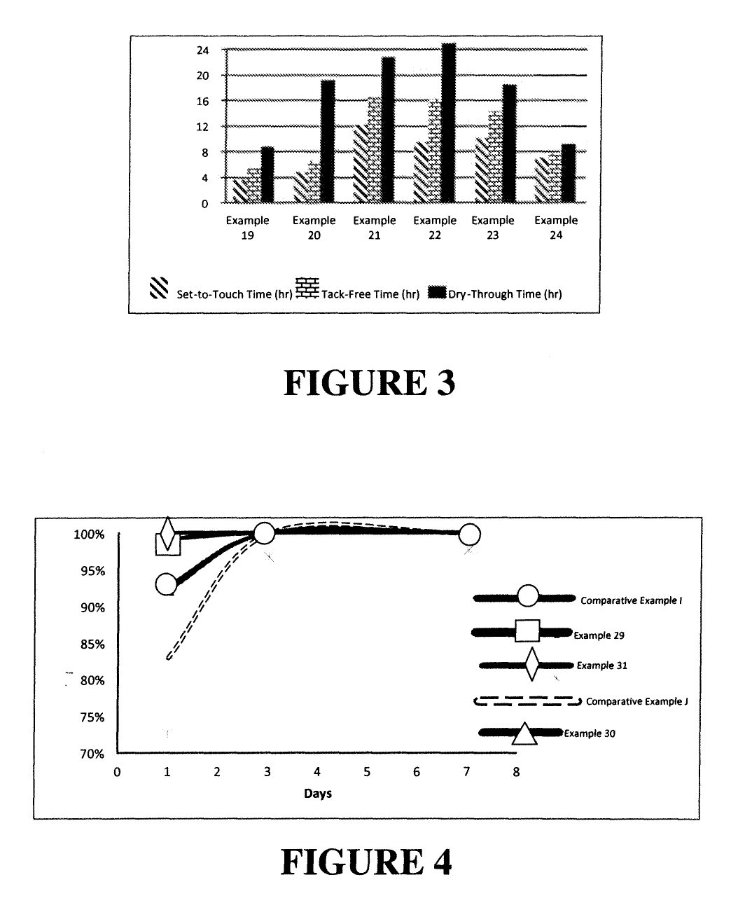

FIG. 3 is a graphical illustration showing dry times of pigmented coatings from cycloaliphatic amine adducted with CHDM epoxy resin curing pigmented CHDM epoxy formulation at ambient temperature. Dry times of 36 hours or less are achieved.

FIG. 4 is a graphical illustration showing % cure by DSC of coatings from adducted cycloaliphatic amines with CHDM epoxy resin (Examples 12, 29, and 30) as well as % cure by DSC of coatings from non-adducted amines (Comparative Examples I and J). The adducted amines show faster cure than the non-adducted analogs as evidenced by the data after 1 day.

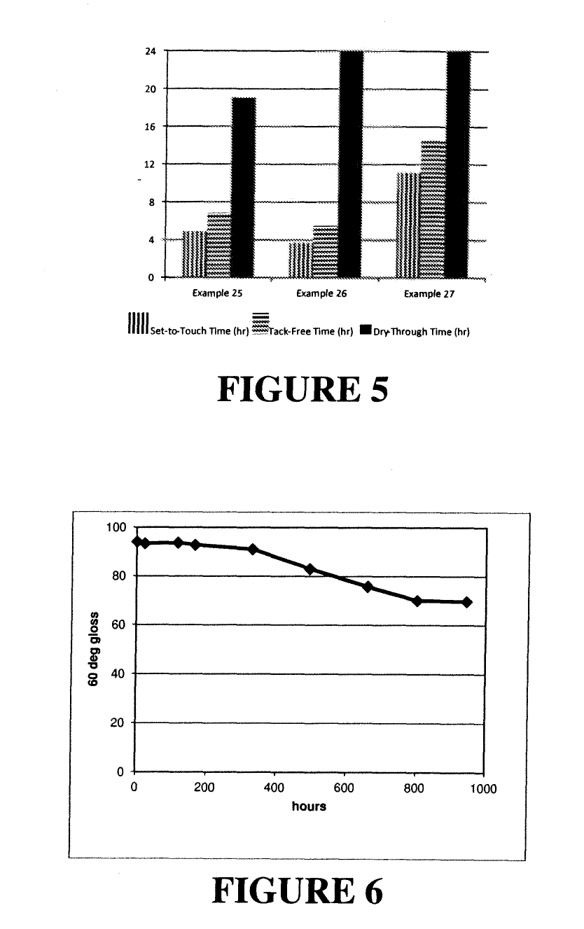

FIG. 5 is a graphical illustration showing dry times of coatings from adducted cycloaliphatic amines with H-BADGE resin (BAC, BPEA, IPDA) curing pigmented H-BADGE formulation at ambient temperature.

TABLE 2
Coating Formulations for Dry Time Measurements

| | | Wt % | | Moles |
|---|---|---|---|---|
| | | DMP | | NH:Moles |
| Example | Curing Agent | 30^{a} | Epoxy | Epoxy |
| Example 12 | Example 2 | 0 | CHDM Epoxy Resin^{b} | 1 |
| Example 13 | Example 2 | 2 | CHDM Epoxy Resin | 1 |
| Example 14 | Example 2 | 0 | CHDM Epoxy Resin | 0.8 |
| Example 15 | Example 5 | 0 | CHDM Epoxy Resin | 1 |
| Example 16 | Example 5 | 2 | CHDM Epoxy Resin | 1 |
| Example 17 | 50:50 blend of | 0 | CHDM Epoxy Resin | 1 |
| | Examples 5 | | | |
| | and 2 | | | |
| Example 18 | 80:20 blend of | 0 | CHDM Epoxy Resin | 1 |
| | Examples 5 | | | |
| | and 2 | | | |
| Example 19 | Example 2 | 0 | Pigmented CHDM | 1 |
| | | | Epoxy^{c} | |
| Example 20 | Example 3 | 0 | Pigmented CHDM | 1 |
| | | | Epoxy | |
| Example 21 | Example 4 | 0 | Pigmented CHDM | 1 |
| | | | Epoxy | |
| Example 22 | Example 5 | 1 | Pigmented CHDM | 1 |
| | | | Epoxy | |
| Example 23 | Example 6 | 1 | Pigmented CHDM | 1 |
| | | | Epoxy | |
| Example 24 | Example 7 | 0 | Pigmented CHDM | 1 |
| | | | Epoxy | |
| Example 25 | Example 10 | 0 | Pigmented H-LER | 1 |
| | | | Epoxy^{d} | |
| Example 26 | Example 9 | 0 | Pigmented H-LER | 1 |
| | | | Epoxy | |
| Example 27 | Example 8 | 0 | Pigmented H-LER | 1 |
| | | | Epoxy | |
| Example 28 | Example 5 | 0 | Pigmented CHDM | 1 |
| | | | Epoxy | |
| Comparative | Comparative | 0 | Pigmented CHDM | 1 |
| Example H | Example G | | Epoxy | |

^{a}weight % of 2,4,6-tris(dimethylaminomethyl)phenol added to the curing agent. CHDM Epoxy Resin is an epoxy resin from 1,4-cyclohexanedimethanol with an epoxide equivalent weight of 142.
^{c}Pigmented CHDM epoxy is a formulation consisting of 50.94 wt % CHDM epoxy resin (EEW 142), 0.76 wt % Bentone SD2, 14 wt % Ti-Pure R706, 26.7 wt % Imsil 1240, and 7.6 wt % Cimbar UF with an overall EEW for the formulation of 279.
Pigmented H-LER epoxy is a formulation consisting of49.83 wt % H-LER epoxy resin (EEW 206), 0.77 wt % Bentone SD2, 14.3 wt % Ti-Pure R706, 27.3 wt % Imsil 1240, and 7.8 wt % Cimbar UF with an overall EEW for the formulation of 413.

Kinetic Analysis by DSC

All glass transition temperatures (T_{g}) and cure kinetics were measured on a TA instrument Q 1000 differential scanning calorimeter (DSC) coupled with an auto sample accessory with a temperature range from −60 to 200° C. A heating rate of 20° min⁻¹ was used during the experiments. The RT cure T_{g} was determined as the temperature at the mid-point of the inflection in the first DSC cycle. The Forced Cure c T_{g} was determined as the temperature at the mid-point of the inflection in the second DSC cycle. For the kinetic runs, the enthalpy was measured in the first DSC cycle.

A mixture of the Part A and the amine curing agent was mixed in a vial on a 5 g scale at a 1:1 molar ratio of NH:epoxy using the components described in Tables 3 and 4. Samples were mixed for ˜1-2 minutes and then 3-7 mg was transferred to a DSC pan. The remainder of the mixture was poured into an aluminum weigh boat and allowed to cure at 25° C.). When it was time to measure the sample again, a small portion of the sample was removed and immediately run in the DSC. The samples were analyzed for enthalpy at ‘time 0’ and at various times over two weeks. The % cure was determined by the following Equation 1.

$$\% Cure = 100 * \frac{( \frac{enthalpy}{g} at time 0 ) - ( \frac{enthalpy}{g} at time t )}{\frac{enthalpy}{g} at time 0} \qquad Equation 1$$

TABLE 3
Formulations For Curing Analysis

| | Curing | | Moles NH: |
|---|---|---|---|
| Example | Agent | Epoxy | Moles Epoxy |
| Comparative | BPEA | CHDM Epoxy Resin^{a} | 1 |
| Example I | | | |
| Example 29 | Example 1 | CHDM Epoxy Resin | 1 |
| Comparative | AEP | CHDM Epoxy Resin | 1 |
| Example J | | | |
| Example 30 | Example 4 | CHDM Epoxy Resin | 1 |
| Example 31 | Example 2 | CHDM Epoxy Resin | 1 |

CHDM Epoxy Resin is an epoxy resin from 1,4-cyclohexanedimethanol with an epoxide equivalent weight of 142, density of 9.963 lbs/gallon.

Table 4 shows the glass transition temperatures of cured coatings prepared from the Example formulations described above.

TABLE 4
Tg After 7-Day Room Temperature Cure; Epoxy:NH ratio of 1:1

| | | | RT | Forced |
|---|---|---|---|---|
| | Curing | | Cure | Cure |
| Example | Agent | Epoxy | Tg (° C.) | Tg (° C.) |
| Example 32 | Example 2 | Pigmented CHDM | 41 | 49 |
| | | Epoxy^{a} | | |
| Example 33 | Example 5 | CHDM Epoxy Resin | 56 | 79 |
| Example 34 | Example 7 | CHDM Epoxy Resin | 56 | 62 |
| Example 35 | Example 4 | CHDM Epoxy Resin | 42 | 46 |

Pigmented CHDM epoxy is a formulation consisting of 50.94 wt % CHDM epoxy resin (EEW 142), 0.76 wt % Bentone SD2, 14 wt % Ti-Pure R706, 26.7 wt % Imsil 1240, and 7.6 wt % Cimbar UF with an overall EEW for the formulation of 279.

TABLE 5
Viscosity of Adducts and Curable Compositions

| | Viscosity |
|---|---|
| Example | (cP at 25° C.) |
| Example 5 | 1640 |
| Example 2 | 31720 |
| Comparative Example G | 5540 |
| Example 6 | 69444 |
| Example 7 | 5560 |
| Example 22 | 288 |
| Example 32 | 1550 |
| Comparative Example H | 880 |

The viscosity of IPDA adduct prepared from low chlorine containing CHDM epoxy resin (Example 5) is significantly lower than that of the corresponding adduct prepared from high chlorine containing CHDM epoxy resin prepared by Lewis acid catalyzed route (Comparative Example G) as shown in Table 6 above. Lower viscosity is also observed when the adducts are formulated into coatings as can be seen by comparing viscosities of the curable composition of Example 22 and Comparative Example H of Table 6 above.

### Example 36

### Coating Gloss Retention

A coating formulation was prepared by mixing the curing agent adduct (Example 11) with pigmented epoxy resin at a 1:1 epoxy:NH stoichiometric ratio. The pigmented epoxy formulation was 50.94 wt % CHDM epoxy resin (EEW 142), 0.76 wt % Bentone SD2, 14 wt % Ti-Pure R706, 26.7 wt % Imsil 1240, and 7.6 wt % Cimbar UF with an overall EEW for the formulation of 279. The coating formulation was then applied to metal panels according to ASTM D4147-99(2007). The coating formulation was poured across the top end of the panel and a 50 μm wire wound drawdown bar was placed behind the mixture. The bar was then drawn with uniform pressure and speed along the length of the panel toward the operator to generate a uniform film. After coating the panels and forming a film thereon, the panels were cured at ambient temperature (about 25° C.) and humidity (about 60%) for 7 days. The panels were then subjected to accelerated weathering by cycling UV A light and condensing humidity on a 4 hour cycle according to ASTM D4587-11, for industrial maintenance coatings.

FIG. 6 shows the gloss retention of a coating derived from a BPEA/IPDA adduct cured with a formulated CHDM epoxy resin.

### Examples 37 and 38

### Coating Gloss as a Function of Accelerated Weathering

A coating formulation for this Example 37 was prepared by mixing the curing agent adduct (Example 5) with CHDM epoxy resin (EEW 142) at a 1:1 epoxy:NH stoichiometric ratio. Benzyl alcohol, 20 wt % based on the mass of the formulation, was included in the coating formulation. Example 38 was prepared analogously to Example 37 except that 1 wt % Tinuvin 123 and 2 wt % Tinuvin 400 (Tinuvin is a product available from BASF) was added based on the combined mass of adduct and epoxy resin.

The coating formulations were then applied to metal panels according to ASTM D4147-99(2007). The coating formulation was poured across the top end of the panel and a 50 μm wire wound drawdown bar was placed behind the mixture. The bar was then drawn with uniform pressure and speed along the length of the panel toward the operator to generate a uniform film. After coating the panels and forming a film thereon, the panels were cured at ambient temperature (about 25° C.) and humidity (about 60%) for 7 days. The panels were then subjected to accelerated weathering by cycling UV B light (0.68 W/cm²) at 60° C. and condensing humidity at 50° C. on a 4 hour cycle for each condition.

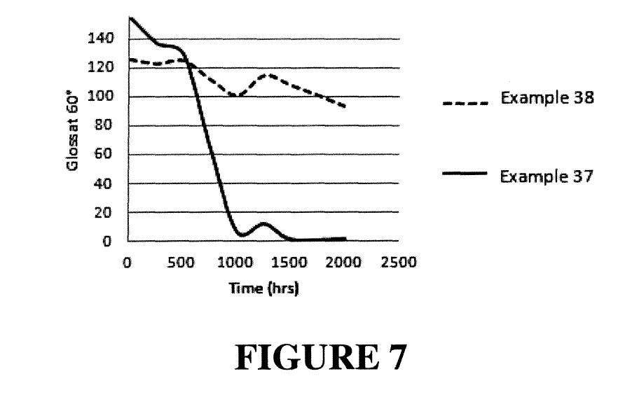

FIG. 7 shows the change in gloss of coatings derived from an IPDA adduct cured with CHDM epoxy resin in the presence and absence of UV stabilizers as a function of accelerated weathering. The stabilizers substantially improve the retention of gloss.

1. An adduct comprising a reaction product of
(a) at least one cycloaliphatic amine compound, and
(b) at least one cycloaliphatic epoxy resin compound; wherein the at least one epoxy resin compound comprises cyclohexanedimethanol epoxy resin; hydrogenated bisphenol A epoxy resin; or mixtures thereof.

2. The adduct of claim 1, wherein the at least one cycloaliphatic epoxy resin compound is 1,4-cyclohexanedimethanol epoxy resin.

3. The adduct of claim 1, wherein the cycloaliphatic amine compound is an ethyleneamine compound.

4. The adduct of claim 3, wherein the cycloaliphatic amine compound comprises bis(2-(piperazin-1-yl)ethyl)amine; aminoethyl piperazine; 2-(4-(2-(piperazin-1-yl)ethyl)piperazin-1-yl)ethanamine; or mixtures thereof.

5. The adduct of claim 4, wherein the cycloaliphatic amine compound comprises bis(2-(piperazin-1-yl)ethyl)amine.

6. The adduct of claim 1, wherein the cycloaliphatic amine compound is a diamine.

7. The adduct of claim 6, wherein the diamine is selected from the group consisting of isophorone diamine; bis-aminomethylcyclohexane; bis(4-aminocyclohexyl)methane; and mixtures thereof.

8. The adduct of claim 1, wherein the mole ratio of the at least one cycloaliphatic amine compound to the at least one cycloaliphatic epoxy resin compound is from about 2 to about 20.

9. A process for preparing an adduct comprising reacting
(a) at least one cycloaliphatic amine compound, and
(b) at least one cycloaliphatic epoxy resin compound; wherein the at least one cycloaliphatic epoxy resin compound comprises 1,4-cyclohexanedimethanol epoxy resin; hydrogenated bisphenol A epoxy resin; or mixtures thereof.

10. A curable epoxy resin composition comprising
(i) an adduct of
(a) at least one cycloaliphatic amine compound, and
(b) at least one cycloaliphatic epoxy resin compound; wherein the at least one cycloaliphatic epoxy resin compound comprises 1,4-cyclohexanedimethanol epoxy resin; hydrogenated bisphenol A epoxy resin; or mixtures thereof; and
(ii) at least one thermosetting epoxy resin compound; said curable composition being curable at ambient temperature and at a predetermined curing time.

11. The curable epoxy resin composition of claim 10, wherein the ratio of the adduct to the at least one thermosetting epoxy resin compound is from about 0.5 mole equivalents to about 1.5 mole equivalents.

12. The curable epoxy resin composition of claim 10, wherein the at least one thermosetting epoxy resin compound comprises 1,4-cyclohexanedimethanol epoxy resin, Unoxol™ epoxy resin, hydrogenated bisphenol A epoxy resin, or mixtures thereof.

13. The curable epoxy resin composition of claim 10, including at least one of a cure catalyst; a second epoxide compound separate and different from the at least one thermosetting epoxy resin compound, a filler, a reactive diluent, a flexibilizing agent, a processing aide, a toughening agent, or a mixture thereof.

14. The curable epoxy resin composition of claim 10, including further the following compound: (iii) at least one accelerator compound; said curable composition being curable at ambient temperature.

15. The curable epoxy resin composition of claim 10, including further the following compound: (iv) a UV stabilizer compound; said curable composition being curable at ambient temperature.

16. The curable epoxy resin composition of claim 15, wherein the concentration of the at least one UV stabilizer compound is from about 0.5 weight percent to about 5 weight percent of the cured coating composition.

17. A process for preparing a curable epoxy resin coating composition comprising admixing:
(i) an adduct of
(a) at least one cycloaliphatic amine compound, and
(b) at least one cycloaliphatic epoxy resin compound; wherein the at least one cycloaliphatic epoxy resin compound comprises 1,4-cyclohexanedimethanol epoxy resin; hydrogenated bisphenol A epoxy resin; or mixtures thereof; and
(ii) at least one thermosetting epoxy resin compound; said curable composition being curable at ambient temperature and at a predetermined curing time.

18. A process for preparing thermoset comprising:
(I) providing a curable composition of
(i) an adduct of
(a) at least one cycloaliphatic amine compound, and
(b) at least one cycloaliphatic epoxy resin compound; wherein the at least one cycloaliphatic epoxy resin compound comprises 1,4-cyclohexanedimethanol epoxy resin; hydrogenated bisphenol A epoxy resin; or mixtures thereof; and
(ii) at least one thermosetting epoxy resin compound; said curable composition being curable at ambient temperature and at a predetermined curing time; and
(II) curing the curable composition of step (I).

19. The process of claim 18, wherein the curing step (II) is carried out at a temperature of from about 10° C. to about 200° C.

20. A cured thermoset article prepared by the process of claim 18.

21. The cured thermoset article of claim 20; wherein the gloss retention under UV exposure is from about 30 percent to 100 percent.

22. The cured thermoset article of claim 20, comprising a weatherable coating.
